(19) United States
(12) Patent Application Publication
(10) Pub. No.: US 2006/0041504 A1
(43) Pub. Date: Feb. 23, 2006

(54) Method, system and program product for deterring credit fraud

(75) Inventors: Richard D. Howard, Enterprise, AL (US); Charles S. Lingafelt, Durham, NC (US); William E. Shembeda, Middletown, NY (US)

Correspondence Address: HOFFMAN, WARNICK & D'ALESSANDRO LLC, 75 STATE ST, 14TH FL, ALBANY, NY, 12207, US

(73) Assignee: International Business Machines Corporation, Armonk, NY (US)

(21) Appl. No.: 10/919,720

(22) Filed: Aug. 17, 2004

(51) Int. Cl. G06Q 40/00

(52) U.S. Cl. 705/38

(57) ABSTRACT

Under the present invention, a credit account can be associated with a locational restriction and a corresponding monetary restriction. The locational restriction sets forth a specific merchant or type of merchant at which a credit account can be used. The monetary restriction sets forth a maximum monetary amount that can be charged to that account by the specified merchant or type of merchant. When a request to approve a purchase using the credit account is received from a merchant, it will be determined whether the locational and monetary restrictions are met. If so, the request is approved. However, if either restriction is not met, the request will be denied.

### BACKGROUND OF THE INVENTION

1. Field of the Invention

In general, the present invention relates to a method, system and program product for deterring credit fraud. Specifically, the present invention provides a way to associate a credit account with locational and monetary restrictions to reduce or eliminate credit fraud.

2. Related Art

As the use of credit accounts such as credit cards increases, credit fraud has reached an all time high. Financial industries estimate that annual losses associated with credit card fraud are in the billions of dollars. These losses have only been increased through the growing use of pervasive devices such as “wands” (e.g., MOBIL SPEEDPASS) and the like that can be swiped at various locations (e.g., gasoline stations) in lieu of producing a credit card or cash. One of the newest illegal activities is targeted at the casual diner. Specifically, when a customer pays with a credit card, a restaurant staff person will take the card out of the customer's sight, presumably to charge the price of the meal. However, in addition to swiping the card through a credit card reader to charge the meal, the staff person will also swipe it through a “black box” that records the number for future uses. The customer may not know that the number has been stolen until he/she receives a statement the next month.

In a recent case, a store clerk placed a fraudulent card reader at the end of the store's credit card reader. Whenever a credit card was swiped through the store's card reader, it was also swiped though the fraudulent card reader. After the store's closing, the clerk removed the fraudulent reader, which by that point had stored every credit card number that was swiped that day. All of this occurred without the customers ever noticing.

This type of credit fraud has only been heightened by the vast availability of “black boxes” and credit card readers over the Internet. Manufacturers are even creating such devices with extremely small dimensions so that they can be attached to a handheld device (e.g., a personal digital assistant) or an authentic credit card reader without being easily noticed. As known, when credit card information is stolen, it can not only be used to make fraudulent purchases, but it can also be used to obtain other credit cards in the original card holder's name. The latter is known as identity theft and can have devastating effects on the original cardholder's credit.

In view of the foregoing, there exists a need for a system that will effectively deter credit fraud. Specifically, a need exists for a system in which account holders can control the nature in which their credit accounts are used. To this extent, a need exists in which an account holder can specify locational and monetary restrictions on the use of his/her credit accounts.

### SUMMARY OF THE INVENTION

In general, the present invention provides a method, system and program product for deterring credit fraud. Specifically, under the present invention, a credit account can be associated with qualifiers such as a locational restriction and a corresponding monetary restriction. The locational restriction sets forth a specific merchant or type of merchant at which a credit account can be used. The monetary restriction sets forth a maximum monetary amount that can be charged to that account by the specified merchant or type of merchant. When a request to approve a purchase using the credit account is received from a merchant, it will be determined whether the locational and monetary restrictions are met. If so, the request is approved. However, if either restriction is not met, the request will be denied.

A first aspect of the present invention provides a method of deterring credit fraud, comprising: providing an association between a credit account, a locational restriction and a corresponding monetary restriction; receiving a request to use the credit account; and making an approval determination for the request based on the associating, wherein the request is approved if the request meets both the locational restriction and the corresponding monetary restriction.

A second aspect of the present invention provides a method of deterring credit fraud, comprising: providing a credit account having a unique identification that is associated with a locational restriction and a corresponding monetary restriction; receiving a request from a merchant to approve a purchase using the credit account for a certain monetary amount; and making an approval determination for the request based on the locational restriction and the corresponding monetary restriction.

A third aspect of the present invention provides a system of deterring credit fraud, comprising: a restriction association system for associating a credit account with a locational restriction and a corresponding monetary restriction; a request reception system for receiving a request to use the credit account; and an approval determination system for making an approval determination for the request, wherein the request is approved if the request meets both the locational restriction and the corresponding monetary restriction.

A fourth aspect of the present invention provides a program product stored on a recordable medium for deterring credit fraud, which when executed, comprises: program code for associating a credit account with a locational restriction and a corresponding monetary restriction; program code for receiving a request to use the credit account; and program code for making an approval determination for the request, wherein the request is approved if the request meets both the locational restriction and the corresponding monetary restriction.

A fifth aspect of the present invention provides a system for deploying an application for deterring credit fraud, comprising: a computer infrastructure being operable to: associate a credit account with a locational restriction and a corresponding monetary restriction; receive a request to use the credit account; and make an approval determination for the request, wherein the request is approved if the request meets both the locational restriction and the corresponding monetary restriction.

A sixth aspect of the present invention provides computer software embodied in a propagated signal for deterring credit fraud, the computer software comprising instructions to cause a computer system to perform the following functions: associate a credit account with a locational restriction and a corresponding monetary restriction; receive a request to use the credit account; and make an approval determination for the request, wherein the request is approved if the request meets both the locational restriction and the corresponding monetary restriction.

A seventh aspect of the present invention provides a method for supporting an application for deterring credit fraud, comprising: supporting the application, wherein the application is operable to perform the following functions: associate a credit account with a locational restriction and a corresponding monetary restriction; receive a request to use the credit account; and make an approval determination for the request, wherein the request is approved if the request meets both the locational restriction and the corresponding monetary restriction.

Therefore, the present invention provides a method, system and program product for deterring credit fraud.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a system for deterring credit fraud according to the present invention.

FIG. 2 depicts an illustrative association of credit accounts with locational restrictions and monetary restrictions according to the present invention.

FIG. 3 depicts an illustrative method flow diagram according to the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

As indicated above, the present invention provides a method, system and program product for deterring credit fraud. Specifically, under the present invention, a credit account can be associated with qualifiers such as a locational restriction and a corresponding monetary restriction. The locational restriction sets forth a specific merchant or type of merchant at which a credit account can be used. The monetary restriction sets forth a maximum monetary amount that can be charged to that account by the specified merchant or type of merchant. When a request to approve a purchase using the credit account is received from a merchant, it will be determined whether the locational and monetary restrictions are met. If so, the request is approved. However, if either restriction is not met, the request will be denied. It should be understood in advance that as used herein the term credit account is intended to mean any type of account that can be used to charge purchases. For example, a credit account could be a credit card account, a line of credit, etc.

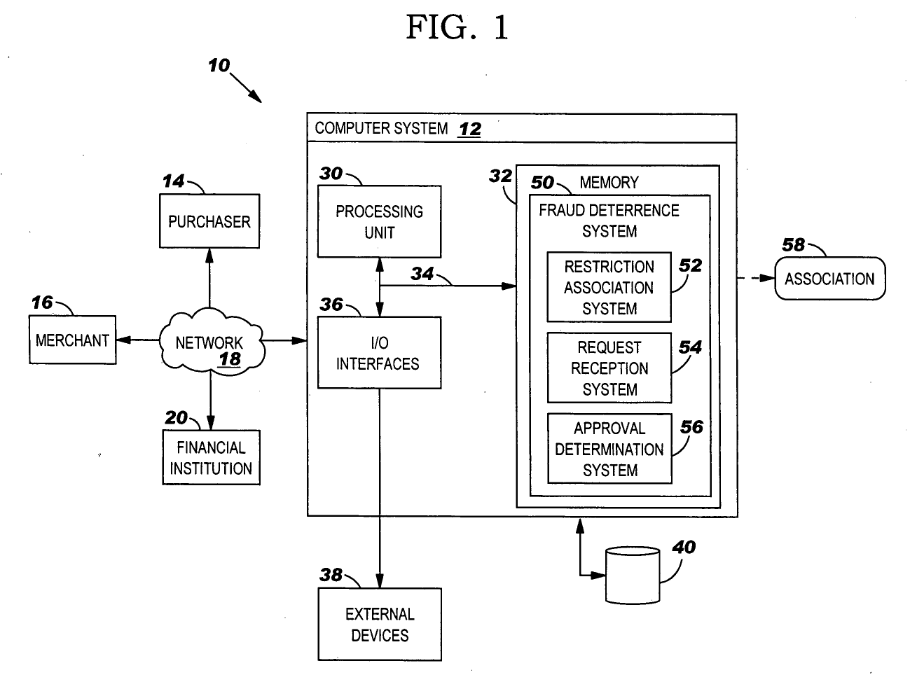

Referring now to FIG. 1, a system 10 for deterring credit fraud is shown is shown. As depicted, system 10 includes computer system 12, purchaser 14 and merchant 16. As will be further described below, computer system 10 allows purchaser 14 to associate his/her credit accounts with locational restrictions and monetary restrictions to help deter or prevent fraud. In general, computer system 12 is intended to represent any type of computer system that is capable carrying out the functions of the present invention. For example, computer system 12 could be a desktop computer, a laptop, a workstation, a server with shared or dedicated computing components, etc. Moreover, in a typical embodiment, computer system 12 communicates with purchaser 14 and merchant 16 over a network 18 in a client-server or server-server environment. To this extent, computer system 12 can serve as both a system for allowing purchasers to associate credit accounts with locational and monetary restrictions, as well as a clearing house or approval center for approving purchases for merchants. For example, purchaser 14 can access a home computer or the like to interface with computer system 12, and associate a credit account with the locational and monetary restrictions. Merchant 16 can later do the same request approval for a would-be purchase using the credit account. The approval determination will depend on whether both the locational and monetary restrictions have been met. In this scenario, merchant 16 might also interface with a financial institution 20 or the like to obtain final approval for the purchase using the credit account. However, it should be appreciated that the functions of computer system 12 and financial institution 20 can be combined. For example, computer system 12 could provide both the fraud deterrence functions of the present invention as well as traditional credit charge authorization functions as currently practiced.

It should be understood merchant 16 could represent a “brick and mortar” operation (e.g., a retail store, restaurant or the like) that purchaser 14 interacts with directly to make purchases. Alternatively, purchaser 14 could interact with merchant 16 over network 18 to make purchases. The same holds true for any perpetrators (not shown) who might attempt to use a credit account belonging to purchaser 14 to make a fraudulent purchase. In the event that communication occurs over network 18, it is understood that purchaser 14 and merchant 18 would utilize computerized systems/devices (not shown) similar to computer system 12.

Network 18 is intended to represent any type of network such as the Internet, a local area network (LAN), a wide area network (WAN), a virtual private network (VPN), etc. As such communication through network 18 could occur via a direct hardwired connection (e.g., serial port), or via an addressable connection that may utilize any combination of wireline and/or wireless transmission methods. Moreover, conventional network connectivity, such as Token Ring, Ethernet, WiFi or other conventional communications standards could be used. Still yet, connectivity could be provided by conventional IP-based protocol. In this instance, an Internet service provider could be used to establish interconnectivity.

As depicted, computer system 12 generally includes processing unit 30, memory 32, bus 34, input/output (I/O) interfaces 36, external devices/resources 38 and storage unit 40. Processing unit 30 may comprise a single processing unit, or be distributed across one or more processing units in one or more locations, e.g., on a client and server. Memory 32 may comprise any known type of data storage and/or transmission media, including magnetic media, optical media, random access memory (RAM), read-only memory (ROM), a data cache, a data object, etc. Moreover, similar to CPU 30, memory 32 may reside at a single physical location, comprising one or more types of data storage, or be distributed across a plurality of physical systems in various forms.

I/O interfaces 36 may comprise any system for exchanging information to/from an external source. External devices/resources 38 may comprise any known type of external device, including speakers, a CRT, LED screen, hand-held device, keyboard, mouse, voice recognition system, speech output system, printer, monitor/display, facsimile, pager, etc. Bus 34 provides a communication link between each of the components in computer system 12 and likewise may comprise any known type of transmission link, including electrical, optical, wireless, etc.

Storage unit 40 can be any system (e.g., a database, etc.) capable of providing storage for information under the present invention. Such information could, among other things, include associations between credit accounts, locational restrictions and monetary restrictions. As such, storage unit 40 could include one or more storage devices, such as a magnetic disk drive or an optical disk drive. In another embodiment, storage unit 40 includes data distributed across, for example, a local area network (LAN), wide area network (WAN) or a storage area network (SAN) (not shown). Although not shown, additional components, such as cache memory, communication systems, system software, etc., may be incorporated into computer system 12. Moreover, it should be understood that any computerized systems/devices used by purchaser 14 and merchant 16 (not shown) will likely include computerized components similar to computer system 12.

Shown in memory 32 of computer system 12 is fraud deterrence system 50, which includes restriction association system 52, request reception system 54 and approval determination system 56. Under the present invention, restriction association system 52 will be used to create associations 58 between credit accounts (e.g., owned by purchaser 14) and qualifiers such as locational restrictions and corresponding monetary restrictions. A locational restriction sets forth a specific merchant or type of merchant at which a credit account is permitted to be used. A monetary restriction sets forth a maximum dollar amount that is permitted to be charged using the credit account at a particular location. Typically, a credit account is associated with a locational restriction and a monetary restriction based on its unique identification (e.g. number) or the like. For example, a credit card account can be associated with locational and monetary restrictions based on the corresponding credit card number.

In a typical embodiment, associations 58 are created by purchaser 14. For example, purchaser 14 could access restriction association system 52 of computer system 12 over network 18 and then be presented with an interface for inputting credit account identifications and associating the same with locational and monetary restrictions. Alternatively, the associations could be created by financial instruction 20 upon the opening of a credit account by purchaser 14. In this case, purchaser 14 could communicate to financial institution 20 the various locational and monetary restrictions. Thereafter, financial institution 20 could access restriction association system 52 and use the interface to make the needed associations.

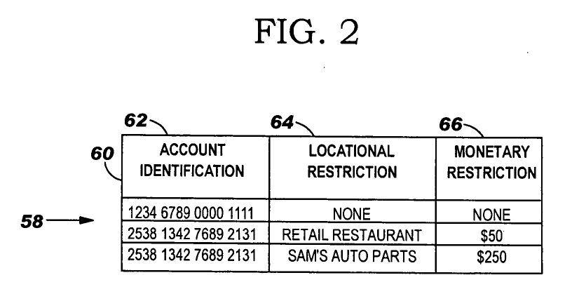

Referring now to FIG. 2, an illustrative table 60 depicting associations 58 for credit accounts owned by purchaser 14 (FIG. 1) are shown. As depicted, purchaser 14 has two credit accounts for which associations have been created. For account identification “1234 6789 0000 1111,” purchaser 14 has designated no locational and monetary restrictions. This indicates that the account corresponding to this identification could be used at any location (merchant) and for any amount (i.e., up to the credit limit). It should be understood that for credit accounts with which no restrictions are desired such as “1234 6789 0000 1111,” purchaser 14 could have alternatively chosen to not include them in table 60 at all. However, as shown, for account identification “2538 1342 7689 2131,” purchaser 14 has set forth two sets of restrictions. In the first instance, purchaser 14 desires this credit account to be used at any retail restaurant for up to $50.00. In the second instance, purchaser 14 desires this credit account to be used only at Sam's Auto Parts store for up to $250. Thus, as can be seen, the present invention not only allows purchaser 14 to designate one or more sets of restrictions for a single credit account, but the present invention also allows the locational restriction to be a specific merchant (e.g., Sam's Auto parts) or a type of merchant (e.g., retail restaurants).

In any event, in order for an intended purchase to be approved, both the locational restriction(s) and the corresponding monetary restriction(s) must be met. For example, if a charge was attempted to account identification “2538 1342 7689 2131,” at a toy store or at a retail restaurant for more than $50.00, the charged would be denied.

Referring back to FIG. 1, this will be explained in further detail. For example, assume that merchant 16 is a retail restaurant at which purchaser 14 is attempting to charge a meal using credit account identification “2538 1342 7689 2131” in the amount of $63.00. Merchant 16 will issue a request to approve the purchase to computer system 12. In a typical embodiment, the request will identify at least merchant 14 and the monetary amount sought to be charged, and will be received/parsed by request reception system 54. Approval determination system 56 will then make the approval determination based on associations 58 (e.g., as stored in storage unit 40). Specifically, approval determination system 58 will determine if both the locational and corresponding monetary restrictions have been met for the purchase. Since the purchase is being attempted at a retail restaurant, the locational restriction has been met. However, because the amount sought to be charged is more than $50.00, the monetary restriction has not be met and the charge should be denied. Even if the charge had met both restrictions, it would then need to be approved by financial institution 20 to ensure that the credit account is valid and the charge is within the available credit limit thereof.

Regardless, as can be seen, by associating credit accounts with locational and monetary restrictions, the chances of a successful fraud and the loss suffered therefrom can be greatly reduced. For example, assume that a perpetrator tried to purchase a stereo for $1000 through an electronics website using credit account identification “2538 1342 7689 2131.” In such a case, the charge would be denied immediately since the locational restriction cannot be met. However, even the locational restriction had been met, the charge would still have to meet the monetary restriction. Even then, it would have to be approved by financial institution 20. It should be noted that, as indicated above, the functions of the present invention that occur within computer system 12, and those performed by financial institution 20, could be combined and performed by a single entity (e.g., by financial institution 20).

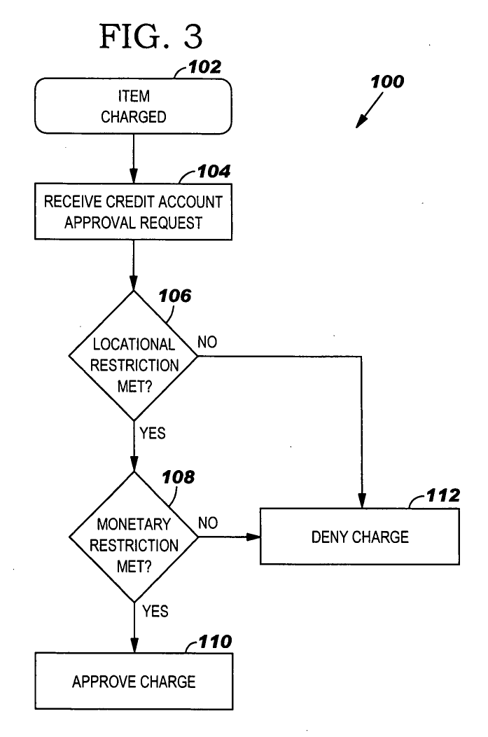

Referring now to FIG. 3, an illustrative method flow diagram 100 according to the present invention is shown. As shown, first step 102 is to charge or attempt to charge an item using a credit account. This will result in a request to approve the charge being received (e.g., by computer system 12 FIG. 1) in step 104. In step 106 it will be determined whether the locational restriction has been met. If not, the charged will be denied in step 112. If, however, the locational restriction has been met, it will be determined in step 108 whether the monetary restriction has been met. If not, the charge will be denied in step 112. However, if both the locational and monetary restrictions have been met in steps 106 and 018, the charge will be approved in step 110.

It should be appreciated that the teachings of the present invention could be offered as a business method on a subscription or fee basis. For example, computer system 12 and/or fraud deterrence system 50 of FIG. 1 could be created, supported, maintained and/or deployed by a service provider that offers the functions described herein for customers. That is, a service provider could offer to associate credit accounts with locational and monetary restrictions as described above. Similarly, as indicated above, computer system 12 could be created, maintained and/or deployed by financial institutions. In such a case, the financial institutions would perform the deterrence functions of the present invention as well as their traditional functions in authorizing purchases (e.g., verifying that the credit account is valid and has sufficient balance to allow an intended purchase).

It should also be understood that the present invention can be realized in hardware, software, a propagated signal, or any combination thereof. Any kind of computer/server system(s)—or other apparatus adapted for carrying out the methods described herein—is suited. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product or a propagated signal, which comprises all the respective features enabling the implementation of the methods described herein, and which—when loaded in a computer system—is able to carry out these methods. Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims. For example, the configuration of fraud deterrence system 50 of FIG. 1 is intended to be illustrative only. As such, fraud deterrence system 50 could be represented by a different configuration of systems. It should also be understood that the qualifiers with which a credit account is associated under the present invention need not be limited to locational and monetary restrictions. For example, a credit account could be associated with time/day-based restrictions, geographic restrictions, etc. Moreover, although the monetary restriction is described above as being a maximum limit, this need not be the case. For example, the monetary restriction could be a minimum monetary amount that must be at least equaled in order for a purchase to be approved.

We claim:

1. A method of deterring credit fraud, comprising:
providing an association between a credit account, a locational restriction and a corresponding monetary restriction;
receiving a request to use the credit account; and
making an approval determination for the request based on the associating, wherein the request is approved if the request meets both the locational restriction and the corresponding monetary restriction.

2. The method of claim 1, wherein the request is denied if the request fails to meet either the locational restriction or the corresponding monetary restriction.

3. The method of claim 1, wherein the providing step comprises associating a unique identification corresponding to the credit account with the locational restriction and the corresponding monetary restriction.

4. The method of claim 3, wherein the associating step comprises associating the unique identification with a plurality of locational restrictions and a corresponding plurality of monetary restrictions.

5. The method of claim 1, wherein the receiving step comprises receiving a request from a merchant to approve a purchase using the credit account for a certain monetary amount, and wherein the request is approved if the merchant meets the locational restriction and the certain monetary amount does not exceed the corresponding monetary restriction.

6. The method of claim 1, wherein the request is received by an approval center, and wherein the approval center accesses the association to make the approval determination.

7. The method of claim 1, wherein the credit account is a credit card account.

8. The method of claim 1, wherein the locational restriction comprises a specific merchant.

9. The method of claim 1, wherein the locational restriction comprises a type of merchant.

10. A method of deterring credit fraud, comprising:
providing a credit account having a unique identification that is associated with a locational restriction and a corresponding monetary restriction;
receiving a request from a merchant to approve a purchase using the credit account for a certain monetary amount; and
making an approval determination for the request based on the locational restriction and the monetary restriction.

11. The method of claim 10, wherein the request is approved if the merchant meets the locational restriction and the certain monetary amount does not exceed the corresponding monetary restriction.

12. The method of claim 10, wherein the request is denied if either the merchant fails to meet the locational restriction or the certain monetary amount exceeds the corresponding monetary restriction.

13. The method of claim 10, further comprising accessing association of the unique identification with the locational restriction and the corresponding monetary restriction to make the approval determination.

14. The method of claim 10, wherein the credit account is a credit card account.

15. The method of claim 10, wherein the locational restriction comprises a specific merchant.

16. The method of claim 10, wherein the locational restriction comprises a type of merchant.

17. A system of deterring credit fraud, comprising:
a restriction association system for associating a credit account with a locational restriction and a corresponding monetary restriction;
a request reception system for receiving a request to use the credit account; and
an approval determination system for making an approval determination for the request, wherein the request is approved if the request meets both the locational restriction and the corresponding monetary restriction.

18. The system of claim 17, wherein the request is denied if the request fails to meet either the locational restriction or the corresponding monetary restriction.

19. The system of claim 17, wherein the restriction association system associates a unique identification corresponding to the credit account with the locational restriction and the corresponding monetary restriction.

20. The system of claim 17, the request reception system receives the request from a merchant to approve a purchase using the credit account for a certain monetary amount, and wherein the request is approved if the merchant meets the locational restriction and the certain monetary amount does not exceed the corresponding monetary restriction.

21. The system of claim 17, wherein the credit account is a credit card account.

22. The system of claim 17, wherein the locational restriction comprises a specific merchant.

23. The system of claim 17, wherein the locational restriction comprises a type of merchant.

24. A program product stored on a recordable medium for deterring credit fraud, which when executed, comprises:
program code for associating a credit account with a locational restriction and a corresponding monetary restriction;
program code for receiving a request to use the credit account; and
program code for making an approval determination for the request, wherein the request is approved if the request meets both the locational restriction and the corresponding monetary restriction.

25. The program product of claim 24, wherein the request is denied if the request fails to meet either the locational restriction or the corresponding monetary restriction.

26. The program product of claim 24, wherein the program code for associating associates a unique identification corresponding to the credit account with the locational restriction and the corresponding monetary restriction.

27. The program product of claim 24, the program code for receiving receives the request from a merchant to approve a purchase using the credit account for a certain monetary amount, and wherein the request is approved if the merchant meets the locational restriction and the certain monetary amount does not exceed the corresponding monetary restriction.

28. The program product of claim 24, wherein the credit account is a credit card account.

29. The program product of claim 24, wherein the locational restriction comprises a specific merchant.

30. The program product of claim 24, wherein the locational restriction comprises a type of merchant.

31. A system for deploying an application for deterring credit fraud, comprising:
a computer infrastructure being operable to:
associate a credit account with a locational restriction and a corresponding monetary restriction;
receive a request to use the credit account; and
make an approval determination for the request, wherein the request is approved if the request meets both the locational restriction and the corresponding monetary restriction.

32. Computer software embodied in a propagated signal for deterring credit fraud, the computer software comprising instructions to cause a computer system to perform the following functions:
associate a credit account with a locational restriction and a corresponding monetary restriction;
receive a request to use the credit account; and
make an approval determination for the request, wherein the request is approved if the request meets both the locational restriction and the corresponding monetary restriction.

33. A method for supporting an application for deterring credit fraud, comprising:
supporting the application, wherein the application is operable to perform the following functions:
associate a credit account with a locational restriction and a corresponding monetary restriction;
receive a request to use the credit account; and
make an approval determination for the request, wherein the request is approved if the request meets both the locational restriction and the corresponding monetary restriction.
